(19) United States
(12) Patent Application Publication
(10) Pub. No.: US 2018/0236371 A1
(43) Pub. Date: Aug. 23, 2018

(54) COLUMN WITH CYLINDRICAL PARTITION

(71) Applicant: JULIUS MONTZ GmbH, Hilden (DE)

(72) Inventors: Helmut JANSEN, Dornagen (DE); Thomas RIETFORT, Bottrop (DE); Egon ZICH, Leichlingen (DE)

(21) Appl. No.: 15/753,298

(22) PCT Filed: Aug. 19, 2016
(86) PCT No.: PCT/EP2016/001410

§ 371 Date: Feb. 17, 2018

(30) Foreign Application Priority Data
Nov. 16, 2015 (DE) 102015014676.9

(51) Int. Cl. B01D 3/14; B01D 3/00

(52) U.S. Cl. CPC B01D 3/141; B01D 3/009

(57) ABSTRACT

The invention relates to a column for carrying out thermal separations and/or chemical reactions with a vertical cylindrical column outer wall that surrounds an inner chamber which is divided by a vertical cylindrical separating wall into two chambers in which substance exchange packets, packages and/or substance exchange bases are arranged, wherein the cylindrical separating wall, as a double wall, has two coaxial cylindrical walls that have radii of different sizes.

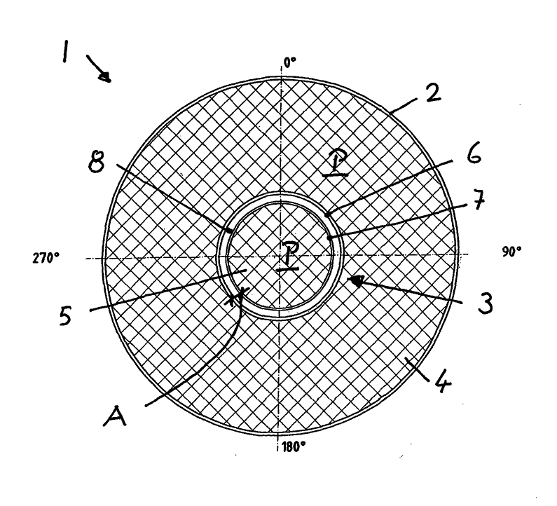

The invention relates to a column for carrying out thermal separations and/or chemical reactions having a vertical cylindrical column outer jacket enclosing an inner chamber that is subdivided by a vertical cylindrical partition into two subchambers holding mass transfer packages, packings and/or mass transfer trays.

It is known to divide the inner chamber of a column by a vertical partition, as is revealed by EP 1 088 577 [U.S. Pat. No. 6,770,173]. It is furthermore known for the vertical partition to be cylindrical. It has been found here that vapor readily condenses on the side of the wall with the higher temperature, thus degrading operation. Vaporization may also occur on the side with the lower temperature. Furthermore, condensation and vaporization relatively frequently disrupt the thermodynamics. Finally, the partition can be subjected to mechanical loads due to differing temperatures that can result in thermal stresses and tilting of the column.

The object of the invention is to avoid the disadvantages that arise in the event of elevated temperature differences on the two sides of a column partition.

This object is achieved according to the invention in that the double-walled cylindrical partition comprises two mutually coaxial cylindrical walls with radii of different sizes.

A partition insulated in this manner prevents condensation and vaporization and so improves the thermodynamics and stability of the column.

An optimum insulation effect is achieved if the radial spacing of the two cylindrical walls from one another amounts to 0.1 to 10 cm, preferably 2 to 5 cm.

It is preferably proposed that the cylindrical walls consist of sheet metal.

It is particularly advantageous for the space of the partition to form a closed dividing chamber. The insulation effect is further improved as a result. The closed space may here have a reduced pressure. It is furthermore proposed that the space that forms the dividing chamber be closed by an upper and/or lower terminating ring.

Precise control of the insulation effect as well as improved insulation are achieved if the space comprises at least one gas inflow port and one gas outflow port. It is also advantageous to this end for the space to comprise air, helium, nitrogen or carbon dioxide.

Exemplary embodiments of the invention are described in greater detail below. The single figure shows a horizontal section through a column at the level of the double partition.

The column 1 for carrying out thermal separations and/or chemical reactions comprises a cylindrical outer jacket 2 with a vertical cylinder axis. The cylindrical column outer jacket 2 encloses an inner chamber in which a cylindrical partition 3, which is of double-walled construction, is located centrally and coaxially to the outer jacket.

The partition 3 that is coaxial to the outer jacket 2 thus divides the column chamber over a specific height range of the column into an outer chamber 4 and an inner chamber 5 located within the partition. Mass transfer packages, packings and/or mass transfer trays P are located in the subchambers 4 and 5.

The cylindrical partition 3 of double-walled construction consists of two cylindrical walls coaxial to one another, specifically of a first cylindrical external inner wall 6 and a second cylindrical inner wall 7 with radii of different sizes to one another, such that an space 8 is formed as a dividing chamber that has a constant spacing A in the form of an annular chamber. This radial spacing A of the two cylindrical walls from one another amounts to 0.1 to 10 cm, preferably 2 to 5 cm.

The cylindrical walls 6, 7 that consist of sheet metal preferably form a closed dividing chamber or space 8, in which the space is closed at the upper and lower ends by an upper and lower terminating ring. The closed space may have a reduced pressure in order to increase the insulating effect.

Precise control of the insulating function of the partition 3 is achieved in that the space 8 comprises at least one gas inflow port and one gas outflow port. The space 8 may here comprise air, helium, nitrogen or carbon dioxide.

In a further development, the closed space may, however, also be closed by a terminating ring only at the top or bottom, such that the space 8 remains open at the top or bottom.

1. A column for carrying out thermal separations and/or chemical reactions, the column comprising:
a vertical cylindrical column outer jacket enclosing an inner chamber; and
a vertical cylindrical partition subdividing the chamber into two subchambers holding mass transfer packages, packings and/or mass transfer trays, the cylindrical partition comprising two mutually coaxial cylindrical walls with radii of different sizes.

2. The column according to claim 1, wherein a radial spacing of the two cylindrical walls from one another is to 0.1 to 10 cm.

3. The column according to claim 1, wherein the cylindrical walls consist of sheet metal.

4. The column according to claim 1, wherein a closed space defined between the walls of the partition forms a closed dividing chamber.

5. The column according to claim 4, claim 5, wherein the space that forms the dividing chamber is closed by an upper and/or lower terminating ring.

6. The column according to claim 4, claim 1, wherein the closed space has a subatmospheric pressure.

7. The column according to claim 4, wherein the space has at least one gas inflow port and one gas outflow port.

8. The column according to claim 1, wherein the space is filled with air, helium, nitrogen or carbon dioxide.
